(19) United States
(12) Patent Application Publication
(10) Pub. No.: US 2009/0128415 A1
(43) Pub. Date: May 21, 2009

(54) ULTRA-WIDE-BAND ANTENNA

(75) Inventors: Jia-Jiu SONG, Jhonghe City (TW); Mu-Kun HSUEH, Kaohsiung City (TW)

Correspondence Address: Workman Nydegger;1000 Eagle Gate Tower, 60 East South Temple, Salt Lake City, UT, 84111, US

(73) Assignee: SMARTANT TELECOM CO., LTD., Jhudong Township (TW)

(21) Appl. No.: 11/941,245

(22) Filed: Nov. 16, 2007

(51) Int. Cl. H01Q 1/38

(52) U.S. Cl. 343/700 MS

(57) ABSTRACT

An ultra-wide-band antenna includes a radiation element, an insulating substrate, a ground element, and a signal line. The insulating substrate is fixed on the ground element, the radiation element is disposed on the insulating substrate for receiving and transmitting a radio signal; the signal line is connected to the radiation element and contacting the ground element for feeding a signal to the radiation element and receiving the radio signal received by the radiation element. The ground element is used to replace a large-area conductive plate of a conventional ultra-wide-band antenna, so as to reduce the volume of the ultra-wide-band antenna, and thus the ultra-wide-band antenna can be placed into an electronic device while occupying smaller space and capable of being miniaturized, thereby realizing a miniaturized ultra-wide-band electronic device.

### BACKGROUND OF THE INVENTION

1. Field of the Invention

The present invention relates to an ultra-wide-band antenna, and more particularly to an ultra-wide-band antenna in a small size.

2. Related Art

Ultra-wide-band is an emerging technology in wireless communication, which is mainly applied in the high-speed data communication in a short distance of about 10 meters or over 100 meters, or even applied in the low-speed communication in a long distance of about 1 kilometer. Two mainstreams for applied in the wireless communication are Bluetooth and IEEE 802.11/a/b/g (54 Mbps/11 Mbps/22 Mbps), but the transmission speed of Bluetooth and IEEE 802.11/a/b/g may be reduced due to the obstacles. However, the ultra-wide-band system transmits data via pulse instead of carrier wave, which thus can pass through the obstacles. Since the signal is transmitted via pulse, the ultra-wide-band system has a quite broad bandwidth, a relatively strong anti-interference capability, and can reduce the power for transmitting the signal, so as to achieve the characteristics of low power and low electricity consumption.

The conical monopole antenna is one of the ultra-wide-band antennas commonly used in the ultra-wide-band wireless communication. FIGS. 1A and 1B show a structure of a conical monopole antenna and an alternative structure thereof The conical monopole antenna structure shown in FIG. 1A includes a conical radiation element 1, a conductive plate 2, and a signal line 3. The conical radiation element 1 is a conical structure for receiving and transmitting a radio signal of a resonance frequency (3 GHz-8 GHz). The signal line 3 vertically penetrates through the conductive plate 2 and connecting to the conical radiation element 1, for transmitting and feeding a current signal out to the conical radiation element 1 and receiving the current signal fed in by the conical radiation element 1. The conductive plate 2 is connected to the signal line 3 to serve as the ground element of the antenna for being connected to the signal line 3 and thus the power is conducted there-between. In the conical monopole antenna, the conical radiation element 1 is used to resonate the received and transmitted radio signal into a current signal, and then the current signal is transmitted through the signal line 3, or the current signal fed in through the signal line 3 is received and resonating into a radio signal to be transmitted by the conical radiation element 1. As for the conical monopole antenna structure shown in FIG 1B, the conical radiation element 1 in FIG. 1A is replaced by a triangular metal 4, so as to greatly reduce the volume of the radiation element, but the conductive plate 2 remains unchanged, which thus has no significant effect on miniaturizing the conical monopole antenna. The current electronic device is developed towards the trend of being portable and miniaturized, but the conventional ultra-wide-band antenna requires a large-area conductive plate for conducting and grounding, which thus is not suitable for the current mainstream of miniaturized electronic devices.

### SUMMARY OF THE INVENTION

In view of the above problem, the present invention is directed to an ultra-wide-band antenna, capable of being combined with the current electronic device through replacing the conductive plate by a ground element, so as to achieve a portable and miniaturized ultra-wide-band electronic device. The electronic device may be a notebook computer, a PDA, or certainly another electronic device.

The ultra-wide-band antenna in the present invention includes a radiation element, an insulating substrate, a ground element, and a signal line. The insulating substrate is fixed on the ground element. The radiation element is disposed on the insulating substrate for receiving and transmitting a radio signal. The shape of the radiation element includes, but not limited to, triangle, semicircle, or semi-ellipse. The signal line is connected to the radiation element and contacting the ground element for feeding a signal into the radiation element and receiving the radio signal received by the radiation element. The signal line includes a signal transmission line, an insulating layer enveloping the signal transmission line, and a ground layer enveloping the insulating layer. The signal transmission line is connected to the radiation element, for transmitting and feeding out a current signal to the radiation element and receiving the current signal fed in by the radiation element. The insulating layer is used for spacing the signal transmission line with the ground layer. The ground layer is used to contact the ground element of the antenna and to conduct power there-between.

By means of the ultra-wide-band antenna, the current signal is transmitted and fed into the radiation element via the signal line, and then the received current signal is resonated into a radio signal by the radiation element. Since the design of the ultra-wide-band antenna requires a large-area conductive plate, we use the ground element to replace the large-area conductive plate of the conventional ultra-wide-band antenna, so as to reduce the volume of the ultra-wide-band antenna, such that the ultra-wide-band antenna can be placed into the electronic device while occupying smaller space and capable of being miniaturized, thereby realizing a miniaturized ultra-wide-band electronic device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1A is a schematic view of a structure of a conventional conical monopole antenna;

FIG. 1B is a schematic view of an alternative structure of the conventional conical monopole antenna;

FIG. 2 is a schematic view of a structure of a first embodiment of the present invention;

FIG. 3 is a schematic view of an insulating substrate fixed on a ground element according to the present invention;

FIG. 4A is another schematic view of the insulating substrate fixed on the ground element according to the present invention;

FIG. 4B is still another schematic view of the insulating substrate fixed on the ground element according to the present invention;

FIG. 5 is a schematic view of a structure of a second embodiment of the present invention;

FIG. 6 is an impedance matching test diagram of an ultra-wide-band antenna of the present invention measured at a frequency between 3 GHz and 8 GHz; and

FIG. 7 shows a table of average gain and peak gain of the ultra-wide-band antenna of the present invention measured at a frequency between 3 GHz and 8 GHz.

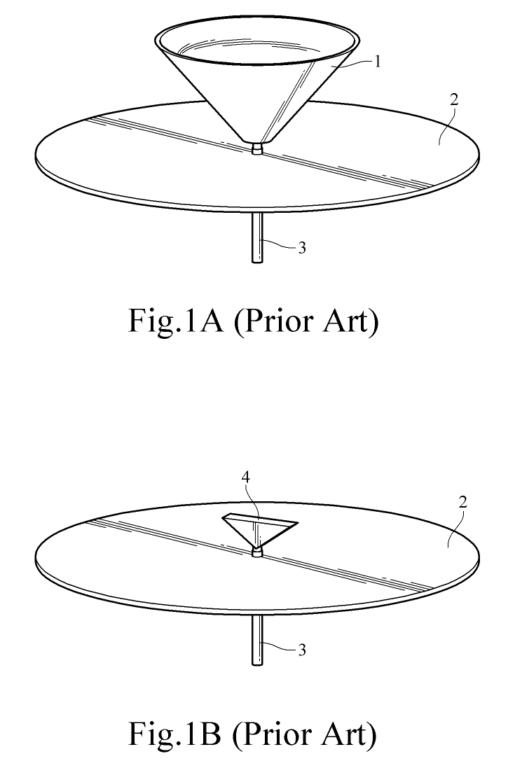

### DETAILED DESCRIPTION OF THE INVENTION

The features and practice of the present invention are illustrated below in detail with reference to the accompanying drawings.

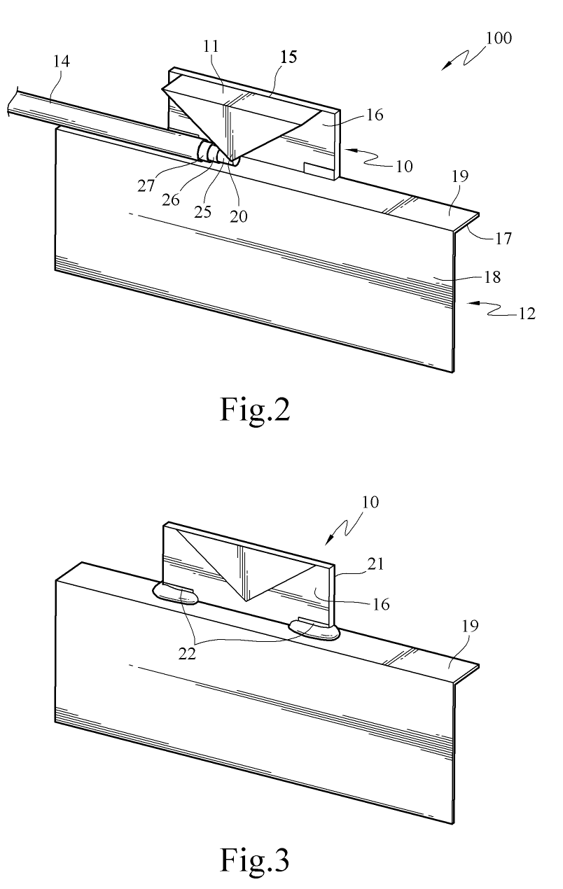

FIG. 2 is a schematic view of a first embodiment of the present invention. The ultra-wide-band antenna 100 includes an insulating substrate 10, a radiation element 11, a ground element 12, and a signal line 14.

As for the radiation element 11, a triangular metal is taken as the radiation body to replace the conical radiation element having a large volume. A side surface 15 of the radiation element 11 is connected to a side surface 16 of the insulating substrate 10. The shape of the radiation element 11 includes, but not limited to, triangle, semicircle, or semi-ellipse. The radiation element 11 may be made of, for example, gold, copper, aluminum, silver, or another conductive metal.

The ground element 12 is a plate-shaped ground element, which includes a first plate element 17 and a second plate element 18. The first plate element 17 and the second plate element 18 are vertically connected to each other. A side surface 19 of the first plate element 17 is used for bearing the insulating substrate 10. The ground element 12 may be made of, for example, gold, copper, aluminum, silver, or another conductive metal.

The inner structure of the signal line 14 seems like a concentric circle, which includes a signal transmission line 25, an insulating layer 26, and a ground layer 27 from inside to outside. The signal transmission line 25 is connected to one end 20 of the radiation element 11, for transmitting and feeding out a current signal to the radiation element 11 and receiving the current signal fed in by the radiation element 11. The ground layer 27 is used to contact the ground element 12 and the power is conducted there-between. The insulating layer 26 is used for spacing the signal transmission line 25 from the ground layer 27. The signal line 14 may be transversely laid on the first plate element 17, or may penetrate through the first plate element 17.

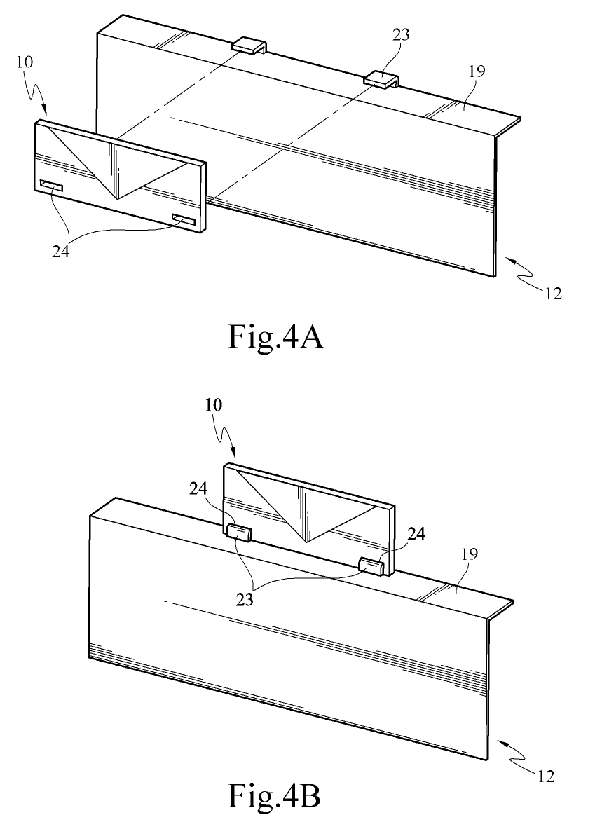

The insulating substrate 10 is made of a plate-shaped insulating material, and connected between the radiation element 11 and the ground element 12, for supporting the radiation element 11 on the ground element 12, and spacing and insulating the radiation element 11 from the ground element 12. The insulating substrate 10 may be made of other insulating materials such as plastic and glass-fiber board (FR4). FIG. 3 is a schematic view of the insulating substrate fixed on the ground element. The insulating substrate 10 includes the other side surface 21 opposite to the side surface 16. A metal layer 22 is formed at the corner of the connection portion between the side surface 16, the other side surface 21 of the insulating substrate 10 and the ground element 12, and then the metal layer 22 is welded to the side surface 19 of the ground element 12 via tin solder. FIGS. 4A and 4B are other schematic views of the insulating substrate fixed on the ground element. Referring to FIG. 4A, at least one L-shaped metal structure 23 is fixed on the side surface 19 of the ground element 12. One end of the at least one L-shaped metal structure 23 is vertically fixed on the side surface 19, and the other end penetrates the penetrating opening 24 on the insulating substrate 10 at the position corresponding to the at least one L-shaped metal structure 23. Referring to FIG. 4B, the end of the L-shaped metal structure 23 penetrating the at least one penetrating opening 24 is bent downwards finally, so as to fix the insulating substrate 10 on the side surface 19 of the ground element 12.

When the signal is transmitted, the current signal is fed into the radiation element 11 through the signal line 14. Then, the current signal is resonated into a radio signal by the radiation element 11. Similarly, once the radiation element 11 senses the radio signal of the resonance frequency and thus generates a current signal, the current signal is fed out to the signal line 14 for being transmitted.

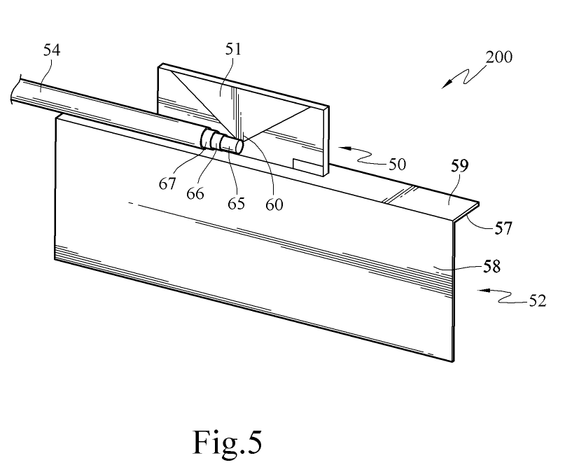

FIG. 5 is a schematic view of a second embodiment of the present application, in which the ultra-wide-band antenna 200 includes an insulating substrate 50, a radiation element 51, a ground element 52, and a signal line 54.

The radiation element 51 is a metal layer formed on the insulating substrate for replacing the conical radiation element having a large volume. The shape of the radiation element 51 includes, but not limited to, triangle, semicircle, or semi-ellipse. The radiation element 51 may be made of copper, aluminum, silver, or another conductive metal.

The ground element 52 is a plate-shaped ground element, which includes a first plate element 57 and a second plate element 58 vertically connected to each other. A side surface 59 of the first plate element 57 is used for bearing and connecting the insulating substrate 50. The ground element 52 may be made of copper, aluminum, silver, or another conductive metal.

The inner structure of the signal line 54 seems like a concentric circle, which includes a signal transmission line 65, an insulating layer 66, and a ground layer 67 from inside to outside. The signal transmission line 65 is connected to one end 60 of the radiation element 51, for transmitting and feeding out a current signal to the radiation element 51 and receiving the current signal fed in by the radiation element 51. The ground layer 67 is used to contact the ground element 52 and the power is conducted there-between. The insulating layer 66 is used for spacing the signal transmission line 65 from the ground layer 67. The signal line 54 may be transversely laid on the first plate element 57, or may penetrate the first plate element 57.

The insulating substrate 50 is made of a plate-shaped insulating material, connected between the radiation element 51 and the ground element 52, for supporting the radiation element 51 on the ground element 52, and insulating and spacing the radiation element 51 from the ground element 52. The insulating substrate 50 may be made of other insulating materials such as plastic and glass-fiber board (FR4). The process for connecting the insulating substrate 50 to the side surface 59 of the ground element 52 is the same as that in the first embodiment, which thus will not repeatedly described herein.

When the signal is transmitted, the current signal is fed in to the radiation element 51 via the signal line 54. Then, the current signal is resonated into a radio signal by the radiation element 51. Similarly, once the radiation element 51 senses the radio signal of the resonance frequency and thus generates a current signal, the current signal is fed out to the signal line 54 for being transmitted.

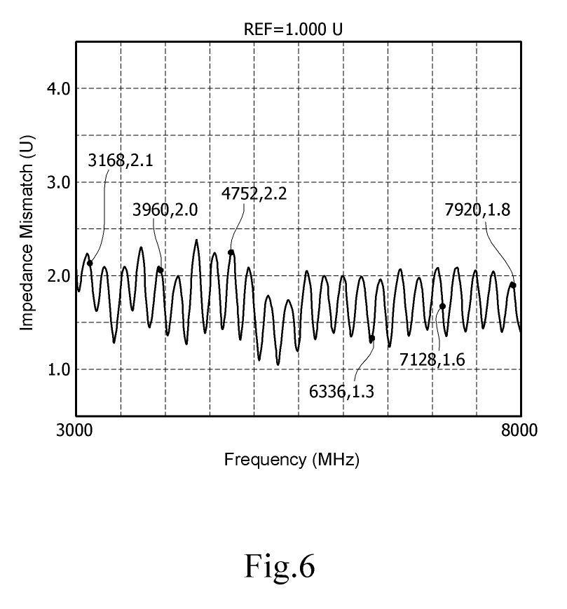

FIG. 6 is an impedance matching test diagram of an ultra-wide-band antenna of the present invention measured at a frequency between 3 GHz and 8 GHz. It can be known from the diagram that, the standing-wave ratio of the ultra-wide-band antenna of the present invention measured at the frequency between 3 GHz and 8 GHz are mostly below 2.0.

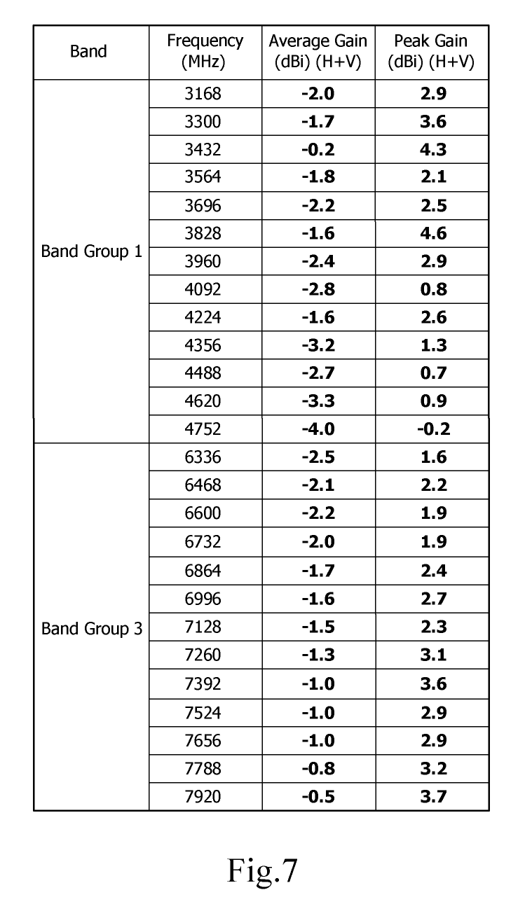

FIG. 7 shows a table of average gain and peak gain of the ultra-wide-band antenna of the present invention measured at a frequency between 3 GHz and 8 GHz.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An ultra-wide-band antenna, applied in an electronic device, comprising:
a ground element;
an insulating substrate, fixed on the ground element;
a radiation element, disposed on the insulating substrate, for receiving and transmitting a radio signal; and
a signal line, connected to the radiation element and contacting the ground element, for feeding a signal to the radiation element and receiving the radio signal received by the radiation element.

2. The ultra-wide-band antenna as claimed in claim 1, wherein the radiation element is a metal.

3. The ultra-wide-band antenna as claimed in claim 1, wherein the radiation element is a metal layer formed on the insulating substrate.

4. The ultra-wide-band antenna as claimed in claim 1, wherein the radiation element is one selected from a group consisting of gold, copper, aluminum, and silver.

5. The ultra-wide-band antenna as claimed in claim 1, wherein the shape of the radiation element is one selected from a group consisting of triangle, semicircle, and semi-ellipse.

6. The ultra-wide-band antenna as claimed in claim 1, wherein the ground element is one selected from a group consisting of gold, copper, aluminum, and silver.

7. The ultra-wide-band antenna as claimed in claim 1, wherein the insulating substrate is one selected from a group consisting of plastic and glass-fiber board.

8. The ultra-wide-band antenna as claimed in claim 1, wherein the signal line comprises a signal transmission line, an insulating layer enveloping the signal transmission line, and a ground layer enveloping the insulating layer.

9. The ultra-wide-band antenna as claimed in claim 1, wherein the insulating substrate is welded onto the ground element.

10. The ultra-wide-band antenna as claimed in claim 1, wherein the ground element further comprises at least one L-shaped metal structure fixed on the ground element for penetrating at least one penetrating opening at the position corresponding to the at least one L-shape metal structure, and one end of the at least one L-shaped metal structure penetrating through the at least one penetrating opening on the insulating substrate is bent downwards to fix the insulating substrate on the ground element.
